(19) United States
(12) Patent Application Publication
(10) Pub. No.: US 2006/0207936 A1
(43) Pub. Date: Sep. 21, 2006

(54) Method for avoiding clogging of filtration membranes

(76) Inventor: Chrystelle Langlais, Le Pecq (FR)

Correspondence Address: CONNOLLY BOVE LODGE & HUTZ LLP, SUITE 800, 1990 M STREET NW, WASHINGTON, DC, 20036-3425, US

(21) Appl. No.: 10/569,206

(22) PCT Filed: Sep. 27, 2004
(86) PCT No.: PCT/FR04/02437

§ 371 Date: Apr. 4, 2006

(30) Foreign Application Priority Data
Sep. 30, 2003 (FR) 0311452

(51) Int. Cl. B01D 65/02

(52) U.S. Cl. 210/636; 210/615; 210/639; 210/778; 210/193; 210/321.69

(57) ABSTRACT

The invention relates to a method for avoiding, or reducing the clogging of filtration membranes, in particular, as used in effluent treatment such as of aqueous wastes, characterised in comprising the addition, to the effluent for filtration, of a natural organic adsorbent for trapping the molecules and particles which clog the filtration membranes.

The present invention relates to a method for improving the performance of filtration membranes that are used in the treatment of effluents, particularly wastewater rich in organic matter such as secondary wastewater. The object of the method of the invention is to prevent the clogging of these membranes.

It is known to a person skilled in the art that micro-, ultra-, nanofiltration membranes or reverse osmosis membranes are vulnerable to the clogging caused by various types of substances: suspended matter, organic matter, biological organisms (bacteria, algae), etc. The identification of these substances and the clogging mechanisms are the subject of numerous investigations described in the literature.

These substances are present in large quantities, for example, in effluents from conventional wastewater treatment systems, giving these effluents a particularly clogging character and thereby jeopardizing the membrane filtration.

The industrial use of the membranes and the management of the particularly clogging character of the effluents treated, particularly of the secondary wastewater rich in clogging substances, is reflected for a person skilled in the art by the installation of restrictive and costly procedures which are recalled below:

1/Curative Measures: These are chemical washing procedures for the purpose of restoring the performance of the membrane when it is clogged. These chemical washing strategies are increasingly aggressive in terms of choice of reagents and their batching, and also in terms of the frequency of application, compromising membrane service life and strongly impacting on the treatment economics: costs of reagents and their management (disposal), cost of the resulting production down time, as well as environmental impacts,

and/or:

2/Preventive Measures: Besides the optimization of the treatment system upstream of the membranes, the installation of a final finishing pretreatment (additional pretreatment) is very often employed for better management of membrane fouling. These preventive measures are reflected by the following treatments, described in the literature and recalled below:

Prechlorination: This is the addition of sodium hypochlorite in contents ranging from 1 to 10 mg/l. This strategy is frequently described in the literature upstream of ultra- and microfiltration membranes, in order to control bioclogging. To this effect, mention may be made of the relevant publications below which describe industrial applications of this technique:
P. Cote et al., 2001, Immersed membrane ultrafiltration for tertiary treatment of sewage effluent, Proc. IWA Congress Wastewater Reclamation and reuse, September 2001, Tel Aviv, Israel;
Van Houtte E. & Verbauwhede J., 2003, Re-use of wastewater effluent for indirect production of drinking water in Flanders, Belgium, Proc. AWWA Congress of Atlanta 2003;
Gullet et al., 2003, Advanced wastewater treatment and water reclamation using membrane filtration in Charlotte, North America, Proc. AWWA Congress of Atlanta 2003.

This option has the following drawbacks in particular:
the production of oxidation byproducts which, depending on the type of membrane used, may not be retained thereon. In this case, the oxidation byproducts are found in the treated water and their removal requires cumbersome and costly post-treatment (reverse osmosis, adsorption, etc.),
the need for a step of dechlorination of the filtered effluents when the residual oxidant content is incompatible with the receiving environment or the type of re-use of the treated water, or with a second membrane stage not resistant to the oxidants (the case of UF or MF and reverse osmosis combinations using composite polyamide membranes, for example).

Addition of chloramines: When the composition of the membrane is incompatible with chlorine (membrane not resistant to oxidants), one alternative to prechlorination is the addition of chloramines. This alternative is described in the literature upstream of polypropylene microfiltration membranes or, more commonly, upstream of reverse osmosis membranes.

Microcoagulation: A second alternative to the prechlorination technique consists in injecting, into the effluent for treatment, before its passage over the membrane, microdoses of a coagulation reagent that destabilizes the colloidal matter in suspension, in order to control the clogging of the membranes. This technique is described in EP-A-1 239 943.

Industrial applications for secondary wastewater treatment are described in:
Van Gottberg et al., 2003, World's largest membrane-based water reuse project, Proc. AWWA Congress of Atlanta 2003;
Wilf M. & Alt S., 2000, Application of low fouling RO membrane element for reclamation of municipal wastewater, Proc. IWA Congress Membrane Drinking and Industrial Water Production, October 2000, Paris, France;
   and the application to seawater treatment is described in:
Brehant A. et al., 2002, Assessment of ultrafiltration as a pretreatment of reverse osmosis membranes for surface seawater desalination, Proc. Conference on Membranes in Drinking Water and Industrial Water Production, Mulheim an der Ruhr, Sep. 22-26, 2002, pp 775-784;
D. Vial et al., 2002, Seawater RO pre-treatment with 0.1 □m Microza®, Proc. 5^{th} Annual IDS Conference on Pre-treatment and Post-treatment Technologies in desalination, Haifa, Israel, Dec. 3-4, 2002, pp 65-71;
D. Vial and Doussau G., 2002, The use of ultrafiltration membranes as seawater pre-treatment prior to reverse osmosis membranes, Desalination, 153, 141-47.

This technical solution has the following drawbacks in particular:
the production of chemical sludge and its management (treatment or disposal),
clogging based on metal hydroxides requiring the application of washing procedures and specific reagents.

In general, all the technical solutions described above incur costs associated with:
the purchase of the chemical reagents,

the management and storage of chemical reagents on site,
the contacting of the membrane with a chemical reagent which, depending on the operating conditions, impacts on the membrane service life,
the generation of pollutant releases requiring treatment that jeopardizes the environmental aspect of the treatment system.

In view of the drawbacks of the techniques currently employed to prevent or at least reduce the clogging of filtration membranes, the invention proposes to provide a method effectively reducing or eliminating this clogging, while improving the hydraulic performance of the membranes, while eliminating the preventive addition of chemical reagents upstream of the membranes, and while reducing the curative use of reagents (chemical washing).

In consequence, this invention relates to a method for preventing or reducing the clogging of filtration membranes used in particular in the treatment of effluents such as wastewater, characterized in that it comprises the addition of a natural organic adsorbent to the effluent for filtration, intended for trapping the molecules and particles which clog the filtration membranes.

According to a preferred embodiment of the method according to the invention, said adsorbent consists of a biological floc having an average dry matter concentration lower than or equal to 2 g/l, this biological floc possibly consisting of biological sludge issuing upstream of the membrane filtration installation, insofar as the installation is a biological treatment station. According to another embodiment, the biological floc may consist of biological sludge issuing from a distinct treatment station, this sludge being injectable in particular into physicochemical potabilization stations for producing drinking water from freshwater, brackish water or seawater.

According to the invention, the biological floc can be introduced either directly into the filtration tank for immersed membrane filtration systems, or into the effluent for filtration before its admission into the membrane, for encased filtration systems. The biological floc can be fed continuously or in batches.

It has been found, surprisingly, that the biological floc traps the particles and molecules which clog the membrane and forms a protective layer on the surface thereof, although the highly clogging character of such a floc is identified in the literature. The method thus characterized is suitable for improving membrane performance and for eliminating any need upstream of the membrane for finishing chemical pretreatment as described above.

Thus, according to the method of the invention, the materials responsible for the clogging character of the effluent are transferred to the biological floc by adsorption, absorption and trapping by flocculation, preventing their direct contact with the membrane. The biological floc also forms a protective layer on the membrane surface, as mentioned above.

The invention ensures the optimized control of the clogging of the membrane, allowing diminished use of chemical reagents for the regeneration phases (chemical washing).

As is well known, the biological floc is produced naturally in wastewater treatment stations employing a biological treatment step. Its presence and management are consequently an integral part of the conventional wastewater treatment installations. Hence the reuse of the biological floc for tertiary treatment causes no change in the material flows on the station.

Furthermore, in the case of aerated membranes, the addition of oxygen to the biological floc in the neighborhood of the membrane has the following supplementary advantages:
it contributes to the stabilization of the biological floc and,
if this biological floc is recycled to a biological reactor, it contributes to reducing its accidental expansion in the upstream treatment system.

Other features and advantages of the present invention will appear from the description given below with reference to the drawing appended hereto, which illustrates two embodiments thereof, and which are nonlimiting. In this drawing:

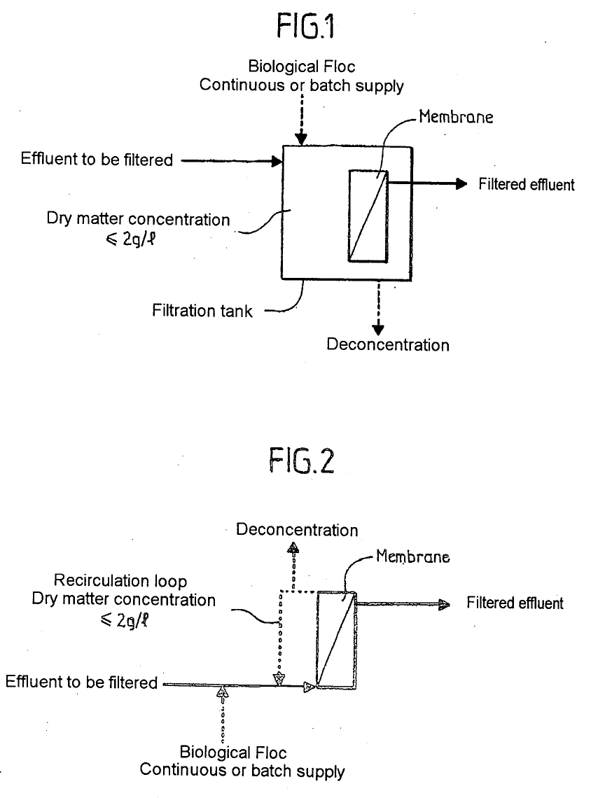

FIG. 1 is a schematic view showing an embodiment of the method of the invention applied to immersed membrane filtration systems, and,

FIG. 2 is also a schematic view showing an exemplary embodiment for encased filtration systems.

In these two embodiments, the natural organic adsorbent added to the effluent and intended for trapping the molecules and particles that clog the membrane consists of biological sludge.

FIG. 1 shows that, in this example of an embodiment, the biological floc, fed continuously or in batches, is introduced into the filtration tank in which the membrane is immersed. In the example illustrated in FIG. 2, the biological floc, which may also be supplied continuously or in batches, is introduced directly into the effluent for filtration before introduction into the membrane.

To illustrate the advantages and technical effects provided by the invention, an exemplary embodiment of the method defined above is described below and, for comparison, examples of embodiments of the technique according to the prior art.

These are tests of ultrafiltration treatment of a municipal waste effluent from an activated sludge type, gravity clarification treatment station. The composition of the secondary effluent is as follows:
Total COD: 40 mg O₂/l
BODs: 7 mgO₂/l
SM: 10±5 mg/l
TOC: 6 mg C/l.

The results of the filtration tests on a commercial ultrafiltration membrane are as follows:

For a normalized filtration flow of 1 and in the absence of pretreatment, the commercial membrane of a known type is very rapidly clogged, the normalized permeability decreases by over 55% in less than 10 h, confirming the need for a finishing pretreatment as mentioned above.

In identical flow conditions, the use of a finishing pretreatment of the prechlorination type serves to control the fouling of the membrane. In this case, the normalized permeability decreases by 40% in 30 days of operation. This fouling is acceptable and illustrates the results that can be obtained with current techniques.

By using the method of the invention as characterized above, that is, by contacting the membrane with a biological floc having an average dry matter concentration of 1.8 g/l in the neighborhood of the membrane, it was found that the clogging of the membrane was very substantially reduced. The normalized permeability of the membrane only decreased by 25% in 30 days of operation, while the filtration flow was increased by 10%.

In this case, the application of the method of the invention serves to reduce the clogging of the membrane while improving the hydraulic performance thereof by nearly 10%, and with no addition of chemical reagents upstream of the membrane. These results serve to delay the implementation of chemical regeneration procedures.

The present invention therefore has many advantages including:
elimination of the preventive use of chemical reagents upstream of the membranes, and hence of the costs incurred by their purchase and use;
diminished curative use of reagents for the regeneration phases and hence of the costs incurred by their purchase and use;
longer membrane service life by reducing its exposure to aggressive chemical substances;
no production of oxidation byproducts;
elimination of any dechlorination post-treatment of the filtered effluent;
no production of physicochemical sludge;
as a consequence of the above points, improved environmental impact of the treatment system,
   and also, in the case of a treatment system including a biological treatment step upstream:
no specific production of biological sludge associated with this finishing pretreatment,
and, finally, reuse of biological floc produced naturally in the treatment installations.

It remains clear that the present invention is not limited to the exemplary embodiments mentioned, but includes all possible variants thereof.

1. A method for preventing or reducing the clogging of filtration membranes used in particular in the treatment of effluents such as wastewater, characterized in that it comprises the addition of a natural organic adsorbent to the effluent for filtration, intended for trapping the molecules and particles which clog the filtration membranes.

2. The method as claimed in claim 1, characterized in that said adsorbent consists of a biological floc having an average dry matter concentration lower than or equal to 2 g/l.

3. The method as claimed in claim 2, characterized in that said biological floc consists of biological sludge issuing upstream of the membrane filtration installation.

4. The method as claimed in claim 2, characterized in that said biological floc consists of biological sludge issuing upstream of a distinct treatment station, this sludge being injectable in particular into physicochemical potabilization stations for producing drinking water from freshwater, brackish water or seawater.

5. The method as claimed in claim 2, wherein the biological floc is introduced directly into the filtration tank.

6. The method as claimed in claim 2, wherein the biological floc is introduced into the effluent for filtration, before the filtration membrane.

7. The method as claimed in claim 1, wherein the biological floc is fed continuously.

8. The method as claimed in claim 1, wherein the biological floc is fed in batches.
